(19) United States
(12) Patent Application Publication
(10) Pub. No.: US 2018/0273097 A1
(43) Pub. Date: Sep. 27, 2018

(54) VEHICLE FRONT STRUCTURE

(71) Applicant: Toyota Jidosha Kabushiki Kaisha, Toyota-shi Aichi-ken (JP)

(72) Inventor: Daisuke Kurokawa, Okazaki-shi Aichi-ken (JP)

(73) Assignee: Toyota Jidosha Kabushiki Kaisha, Toyota-shi Aichi-ken (JP)

(21) Appl. No.: 15/915,584

(22) Filed: Mar. 8, 2018

(30) Foreign Application Priority Data
Mar. 21, 2017 (JP) 2017-054841

(51) Int. Cl. B62D 21/15; B62D 21/11; B62D 25/04; B62D 25/08; B62D 25/14; B62D 27/02

(52) U.S. Cl. CPC B62D 21/152; B62D 21/11; B62D 27/02; B62D 25/088; B62D 25/145; B62D 25/04

(57) ABSTRACT

A vehicle front structure includes: a dash panel; a front side member; a suspension tower coupled to a upper part of the front side member; a dash cross member attached to the dash panel, the dash cross member being located at a more vehicle-upward position than a upper end of the suspension tower; and a suspension tower brace including a first coupling portion coupled to the upper end of the suspension tower and a second coupling portion coupled to the dash cross member. The first coupling portion is located at a more vehicle-downward position than the second coupling portion.

### CROSS-REFERENCE TO RELATED APPLICATIONS

This application claims priority to Japanese Patent Application No. 2017-054841 filed on Mar. 21, 2017, which is incorporated herein by reference in its entirety including the specification, drawings and abstract.

### BACKGROUND

### 1. Technical Field

The present disclosure relates to a vehicle front structure.

### 2. Description of Related Art

In a structure in which suspension towers and a front pillar, which are located in a front part of an automobile, are connected by suspension tower braces so as to release a collision load from the suspension towers to the front pillar, there has been proposed such a structure that mechanical strength of the suspension tower braces is adjusted so as to reduce torsion of the front pillar at the time of a front collision, and also suppress the suspension towers from moving rearward (see Japanese Patent Application Publication No. 2009-179294 (JP 2009-179294 A)).

### SUMMARY

By the way, front side members as major structural members extending in the vehicle-longitudinal direction are provided in a front part of an automobile. The front side members are configured to transmit a load from a vehicle front face to strength members disposed under a cabin. Accordingly, when a collision load is applied from the vehicle front face, the front side members receive a reaction force acting upward from the strength members located under the cabin, and might be deformed in a manner as to be curved in the vehicle-upward direction. Each front side member is designed to be curved in the vehicle-width direction and crushed in the vehicle-longitudinal direction, to thereby absorb the collision load; thus, the front side member can receive only a small collision load when the front side member is curved in the vehicle-upward direction.

In the structure described in JP 2009-179294 A, it is possible to suppress the suspension towers from moving rearward, but it is impossible to suppress the front side members from being deformed in the vehicle-upward direction; therefore, there is still room for improvement in light of suppressing the dash panel located behind the front side member from moving rearward.

To cope with this, the present disclosure provides a vehicle front structure capable of suppressing the front side members from being deformed in the vehicle-upward direction at the time of a front collision so as to suppress the dash panel from moving rearward.

An aspect of the disclosure provides a vehicle front structure. The vehicle front structure according to the aspect includes: a dash panel partitioning a part frontward of a cabin; a front side member disposed frontward of the dash panel in a vehicle-longitudinal direction; a suspension tower coupled to a upper part of the front side member; a dash cross member attached to the dash panel and extending in a vehicle-width direction, the dash cross member being located at a more vehicle-upward position than a upper end of the suspension tower; and a suspension tower brace having a first end coupled to the dash cross member and a second end coupled to the upper end of the suspension tower. The suspension tower brace includes a first coupling portion coupled to the upper end of the suspension tower and a second coupling portion coupled to the dash cross member. The first coupling portion is located at a more vehicle-downward position than the second coupling portion.

In the aspect, the suspension tower brace may be connected to the upper end of the suspension tower at the first coupling portion, and may be connected to the dash cross member at the second coupling portion, so as to connect the upper end of the suspension tower brace to the dash cross member in the vehicle-longitudinal direction, and the suspension tower brace may extend in such a manner as to be inclined in a vehicle-vertical direction relative to the vehicle-longitudinal direction.

In the aspect, in the vehicle front structure of the present disclosure, each suspension tower brace may include a strength-reduced portion in the vicinity of the first coupling portion.

In the aspect, the strength-reduced portion may have a smaller bending strength than bending strength of other portions in the suspension tower brace.

In the aspect, the suspension tower brace may include a web and two flanges, the two flanges facing each other, the web being between the two flanges, the web and the two flanges may be arranged such that the web is located at a more vehicle-upward position than the two flanges, the two flanges extending in a vehicle-vertical direction, the two flanges may be coupled to the dash cross member, the web being coupled to the upper end of the suspension tower, and a hole configuring the strength-reduced portion may be provided on the web in the vicinity of the first coupling portion.

In the aspect, a height in the vehicle-vertical direction of each flange of the two flanges may be lowered from the second coupling portion toward the first coupling portion.

In the aspect, the vehicle front structure may include a front pillar disposed at a more vehicle-rearward position compared with the dash panel; and a front-pillar inner gusset coupled to the front pillar. An end of the dash cross member in the vehicle-width direction may be coupled to the front-pillar inner gusset.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view showing a frame structure of a body of an automobile including a front structure of an embodiment;

FIG. 2 is a perspective view showing the front structure of the embodiment, as viewed from a vehicle front;

FIG. 3 is a perspective view showing the front structure of the embodiment, as viewed from a vehicle rear;

FIG. 4 is a side view showing the front structure of the embodiment;

FIG. 5 is a plan view showing the front structure of the embodiment;

FIG. 6A is a drawing showing a perspective view of a suspension tower brace in the front structure of the embodiment;

FIG. 6B is a sectional view showing a section taken along line VIB-VIB in FIG. 6A;

FIG. 6C is a sectional view showing a section taken along line VIC-VIC in FIG. 6A;

FIG. 6D is a sectional view showing a section taken along line VID-VID in FIG. 6A;

FIG. 7 is a side view showing load transmission and deformation immediately after the automobile including the front structure of the embodiment experiences a front collision;

FIG. 8 is a side view showing load transmission and deformation in the first half period of the front collision of the automobile including the front structure of the embodiment; and

FIG. 9 is a side view showing load transmission and deformation in the last half period of the front collision of the automobile including the front structure of the embodiment.

### DETAILED DESCRIPTION OF EMBODIMENTS

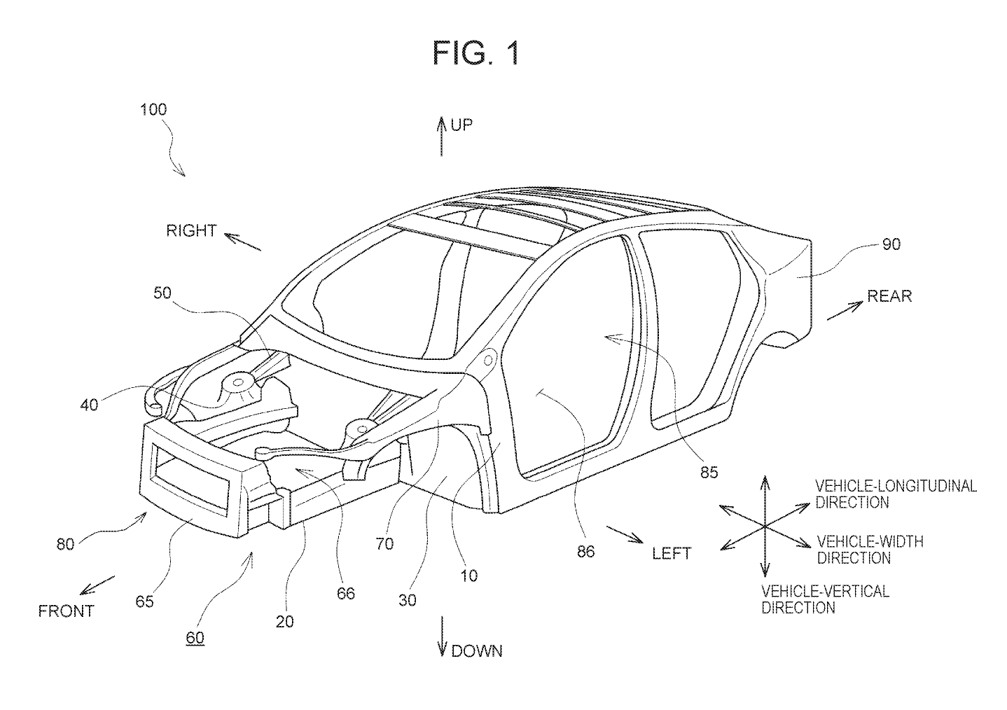

Hereinafter, a front structure 60 of a vehicle according to an embodiment will be described with reference to the drawings. First, with reference to FIG. 1, a body structure of an automobile 100 in which the front structure 60 of the present embodiment is incorporated will be described. As shown in FIG. 1, the automobile 100 includes a frame structure composed by metal such as aluminum. The automobile 100 includes a front frame 80 located more frontward than front pillars 10, a rear frame 90, and a cabin frame 85 forming a cabin 86 disposed between the front pillar 10 and the rear frame 90. The front frame 80 includes a front reinforcement member 65 connected to a not-illustrated front bumper, front side members 20 connected to the front reinforcement member 65, a dash panel 30 partitioning the cabin 86 from an engine room 66, front pillars 10, and an upper member 70 connected to the front pillars 10, and extending in the vehicle-frontward direction. Each suspension tower 40 in which a suspension system of each front wheel is accommodated is provided between each front side member 20 and the upper member 70. A suspension tower brace 50 connects each suspension tower 40 to the dash panel 30.

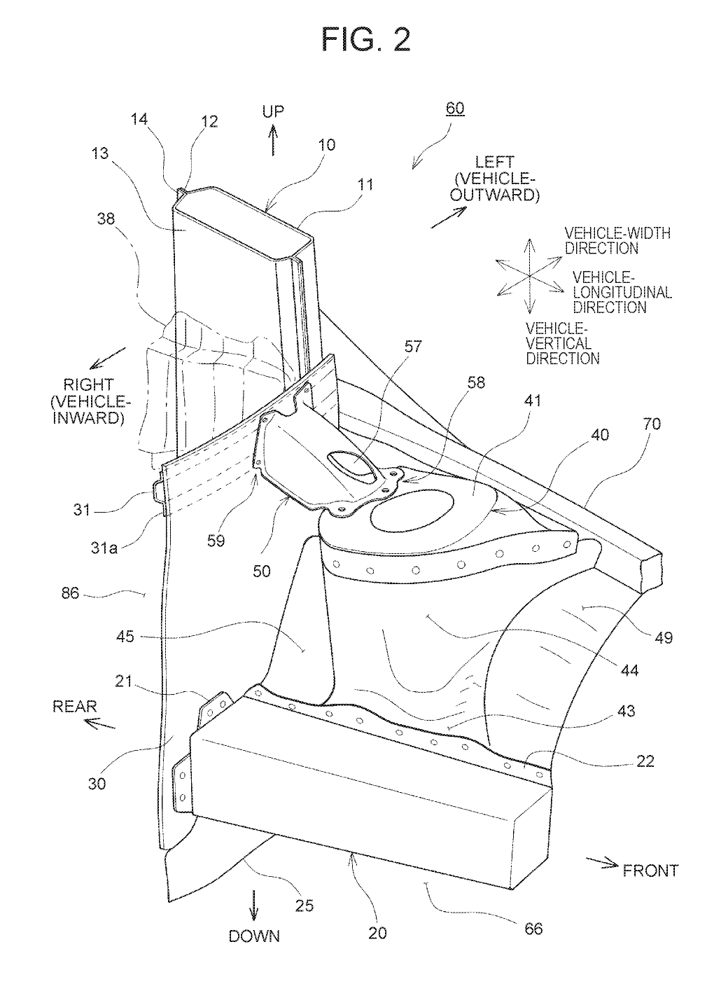

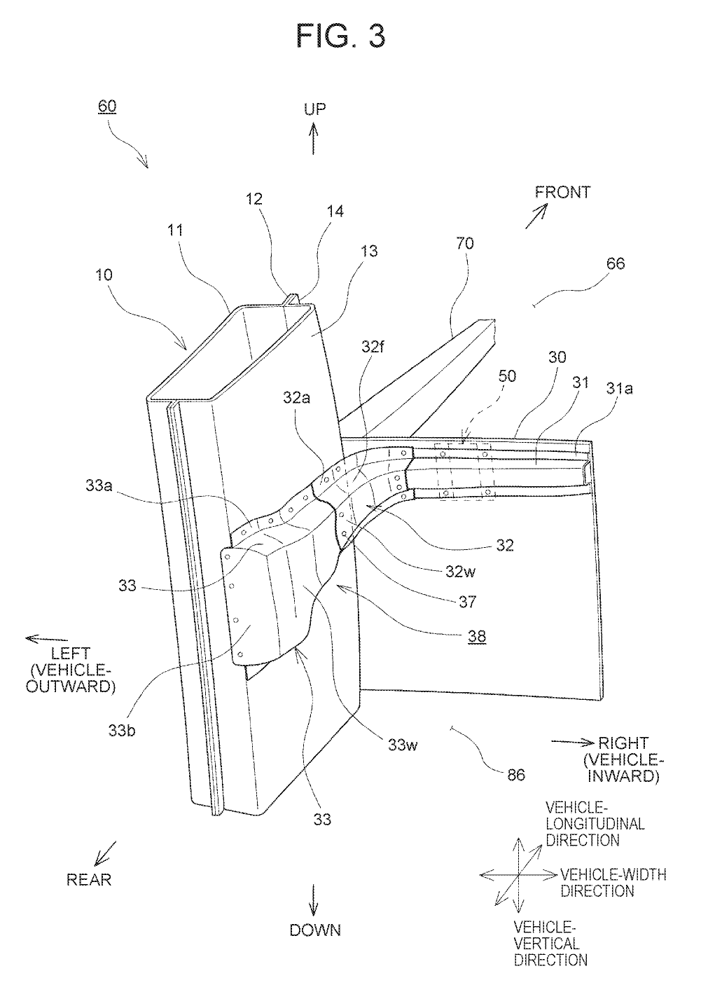

As shown in FIG. 2, the front structure 60 includes the dash panel 30, a dash cross member 31 attached to the dash panel 30, the front side members 20, the suspension towers 40, and the suspension tower braces 50. As shown in FIG. 3, each end in the vehicle-width direction of the dash cross member 31 is coupled to a front-pillar inner gusset 38 coupled to each front pillar 10.

The dash panel 30 is a plate member partitioning the engine room 66 from the cabin 86. As shown in FIG. 2 and FIG. 3, the dash cross member 31 is formed by bending a thin metallic plate into a groove shape so as to form stripe-shaped coupling ribs 31a at side ends of this bent portion. The dash cross member 31 is coupled to the dash panel 30 by spot-welding the coupling ribs 31a to the dash panel 30 so as to reinforce the dash panel 30.

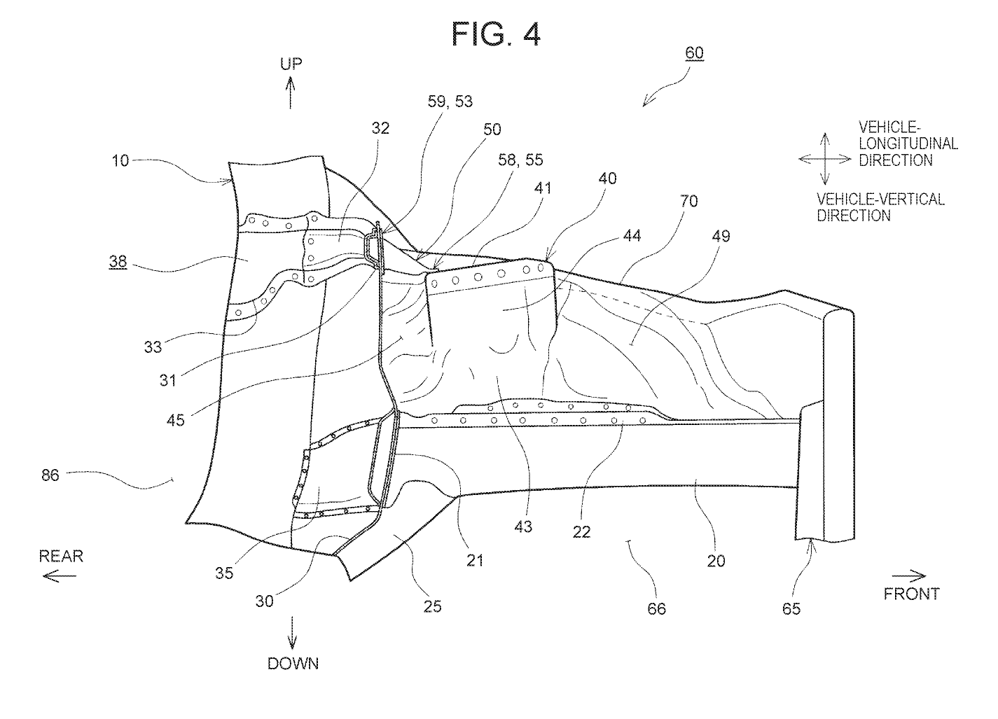

As shown in FIG. 1 and FIG. 2, the front side members 20 are major structural members disposed frontward of the dash panel 30, and extending in the longitudinal direction of the automobile 100. The engine, a motor for driving, and others are installed between the front side members 20. A front end of each front side member 20 is coupled to the front reinforcement member 65, and a rear end thereof is coupled to the dash panel 30 by spot-welding a coupling rib 21 of the front side member 20 to the dash panel 30. As shown in FIG. 4, a cross reinforcement member 35 is attached to a part of the dash panel 30, the part located on the cabin 86 side to which each front side member 20 is connected. This cross reinforcement member 35 is coupled to the front pillar 10. Each front side member 20 transmits a load from the front reinforcement member 65 via the cross reinforcement member 35 to the front pillar 10. A connecting member 25 disposed along the dash panel 30 is connected to a lower part of the rear end of each front side member 20. The connecting member 25 is a strength member curved from the lower surface of the front side member 20 toward a position under the cabin 86, and is connected to a not-illustrated cabin-lower-part strength member disposed under the cabin 86. Each front side member 20 transmits a load from the front reinforcement member 65 via the connecting member 25 to the cabin-lower-part strength member.

As shown in FIG. 2, each suspension tower 40 is a cylindrical member located at a vehicle-frontward position from the dash panel 30, the suspension tower 40 in which the suspension system for each front wheel provided between each front side member 20 and the upper member 70 is accommodated. The suspension tower 40 includes: a cylindrical portion 44 in which the suspension system of each front wheel is accommodated; a cowling portion 43 connected from the cylindrical portion 44 to an upper surface and a side surface of the front side member 20; a first wheel house 49 connected to a front part of the cylindrical portion 44 and covering an upper part of the front half of the front wheel; and a second wheel house 45 attached between the cylindrical portion 44 and the dash panel 30 so as to cover an upper part of the rear half of the front wheel. Each of the cowling portion 43, the first and second wheel houses 49, 45 is formed by press-forming a plate-like metallic material. A lower end of the cowling portion 43 is coupled to a coupling rib 22 formed to an upper part of the front side member 20 by spot-welding or the like. An upper end 41 of the cylindrical portion 44 is coupled to the upper member 70. The first wheel house 49 is coupled to the upper member 70 and the front side member 20. The second wheel house 45 is coupled to a front part in the vehicle-longitudinal direction of the dash panel 30.

As shown in FIG. 2 and FIG. 4, one end of the suspension tower brace 50 is coupled to the dash panel 30 and the dash cross member 31, and the other end thereof is coupled to the upper end 41 of the suspension tower 40. As shown in FIG. 2 and FIG. 4, the dash cross member 31 is located at a more vehicle-upward position than the upper end 41 of the suspension tower 40, and thus the suspension tower brace 50 is inclined to connect the upper end 41 of the suspension tower 40 to the dash panel 30 and the dash cross member 31 in the vehicle-longitudinal direction in such a manner that a first coupling portion 58 relative to the upper end 41 of the suspension tower 40 is located at a more vehicle-downward position than a second coupling portion 59 relative to the dash cross member 31.

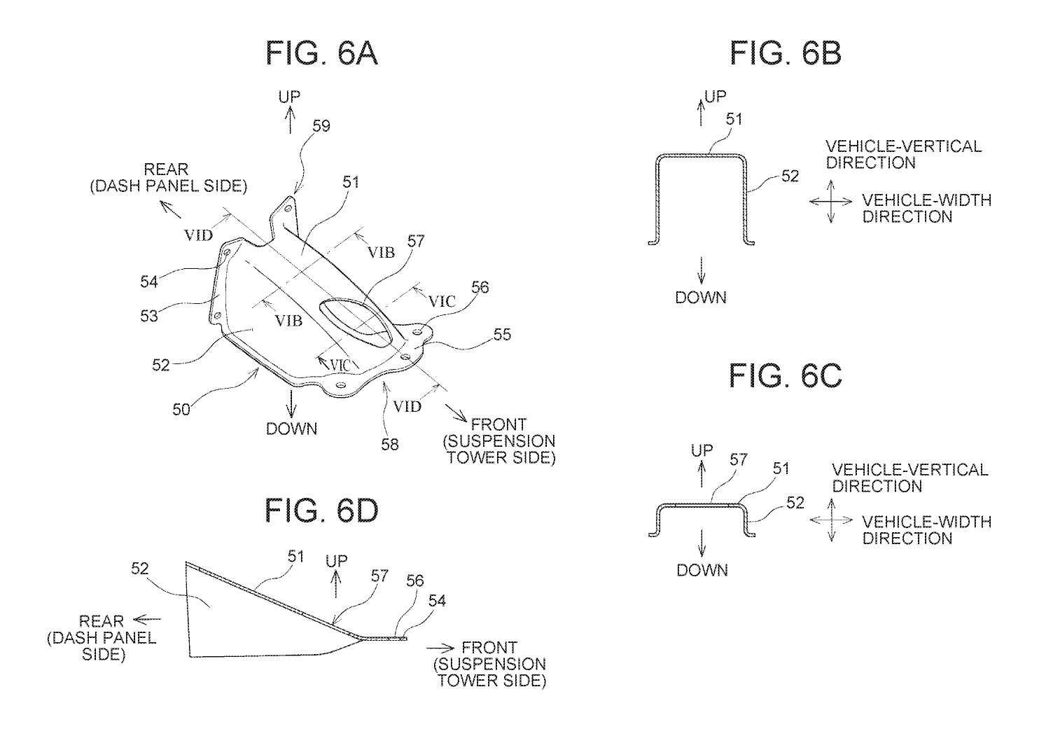

FIG. 6A is a perspective view of the suspension tower brace 50, FIG. 6B is a VIB-VIB section shown in FIG. 6A, that is a sectional view showing a section of the suspension tower brace 50 on the dash panel side; FIG. 6C is a VIC-VIC section shown in FIG. 6A, that is, a sectional view showing a section of the suspension tower brace 50 on the suspension tower side; and FIG. 6D is a VID-VID section shown in FIG. 6A, that is, a vehicle-longitudinal section of a center of the suspension tower brace 50.

As shown in FIG. 6A to FIG. 6C, the suspension tower brace 50 is a grooved-sectional member including a web 51 and two flanges 52 that oppose each other with the web 51 interposed therebetween, and the web 51 is located at a more vehicle-upward position than the flanges 52, and the flanges 52 extend in the vehicle-vertical direction. As shown in FIG. 6B to FIG. 6D, the height of each flange 52 is lowered from the dash panel side (the second coupling portion 59 side) toward the suspension tower side (the first coupling portion 58 side). As shown in FIG. 6A and FIG. 6D, a hole 57 is provided in the vicinity of the first coupling portion 58 of the web 51 relative to the suspension tower 40. This hole 57 configures a strength-reduced portion to reduce compressive strength and bending strength of the suspension tower brace 50.

As shown in FIG. 6A, a part on the dash panel side of each flange 52 is provided with a stripe-shaped coupling rib 53 extending in the vehicle-width direction. The coupling rib 53 is formed with a spot-welding point 54. As shown in FIG. 4, the coupling rib 53, the dash panel 30, and a coupling rib 31a of the dash cross member 31 are integrally spot-welded so as to couple the flanges 52 to the dash cross member 31. A part on the suspension tower side of the web 51 is provided with a stripe-shaped coupling rib 55. The coupling rib 55 is provided with a spot-welding point 56. The coupling rib 55 is coupled to the upper end 41 of the suspension tower 40 by spot-welding.

As shown in FIG. 2 and FIG. 3, the front pillar 10 is a long hollow member formed in a substantially square cylindrical shape by connecting a stripe-shaped connection rib 12 of a front-pillar outer panel 11 as a long member having a thin-wall grooved section and a stripe-shaped connection rib 14 of a front-pillar inner panel 13 as a long member having a thin-wall grooved section.

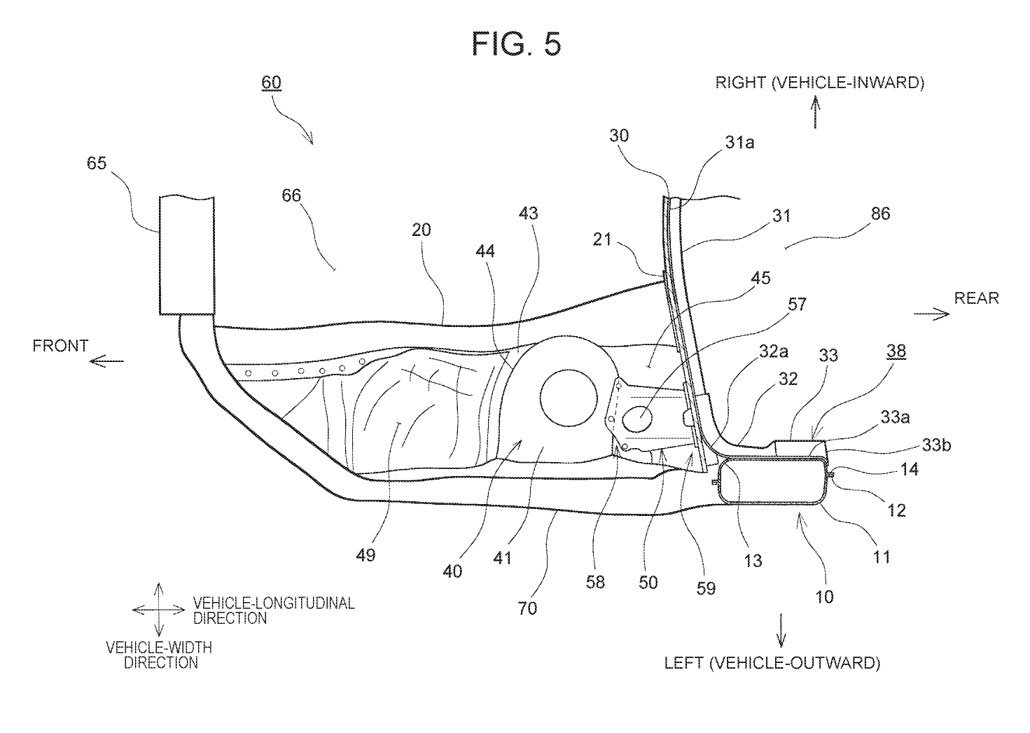

As shown in FIG. 3 and FIG. 5, each front-pillar inner gusset 38 includes a gusset body 33 and a front-pillar brace 32. As shown in FIG. 3, the gusset body 33 has a box-like shape whose width is gradually narrower toward the vehicle front, and whose periphery is provided with a stripe-shaped coupling rib 33a in contact with an outer side surface of the front-pillar inner panel 13. The coupling rib 33a is welded to the outer side surface of the front-pillar inner panel 13 by spot-welding. A coupling portion 33b located at a vehicle-rearward position of the gusset body 33 is joined to a rear side surface in the vehicle-longitudinal direction of the front-pillar inner panel 13 by spot-welding. The front-pillar brace 32 is an arc shape member that connects the front pillar 10 to the dash cross member 31, and a section of the front-pillar brace 32 is bent into a groove shape so as to form stripe-shaped coupling ribs 32a at side ends of respective erecting portions 32f. An end on the dash panel 30 side of the coupling rib 32a is coupled to the dash cross member 31 by bolts or spot-welding. In addition, a projecting portion 32w of the front-pillar brace 32 is coupled to a projecting portion 33w of the gusset body 33 by bolts 37.

As aforementioned, the end in the vehicle-width direction of the dash cross member 31 is coupled to the front-pillar inner gusset 38, and the front-pillar inner gusset 38 is coupled to the front pillar 10.

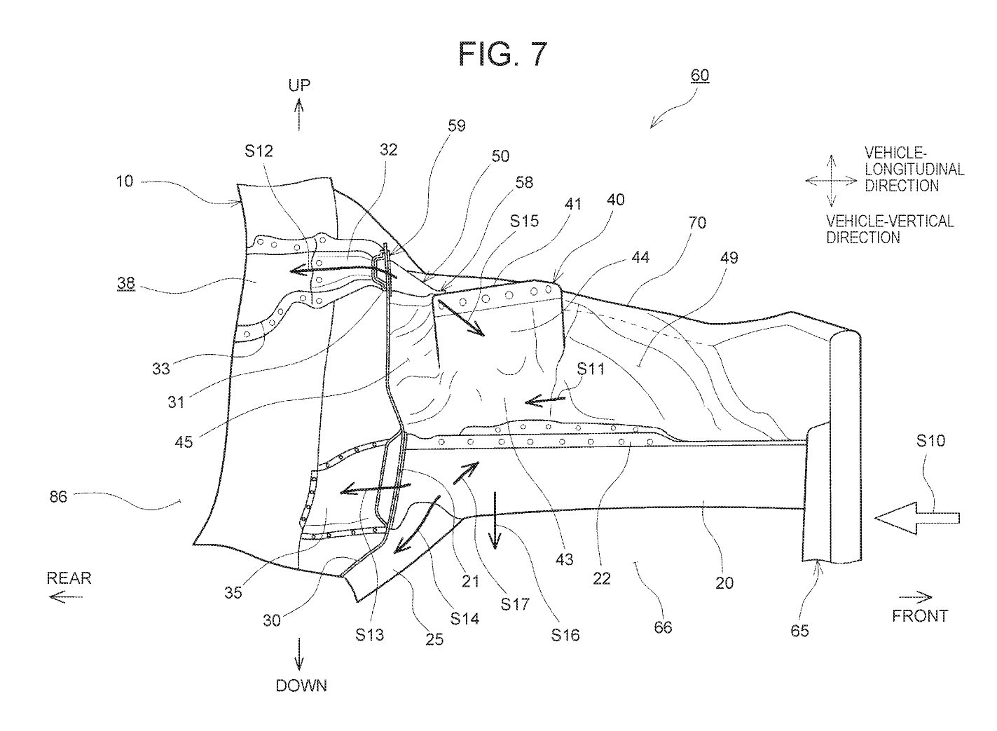

Next, with reference to FIG. 7 to FIG. 9, transmission of a collision load applied to the front reinforcement member 65 and deformations of the respective components when the automobile 100 including the above-configured front structure 60 experiences a front collision.

When the automobile 100 experiences a front collision, a collision load is applied to the front reinforcement member 65, as indicated by an outlined arrow S10 in FIG. 7. The collision load applied to the front reinforcement member 65 is transmitted to each front side member 20, and pushes each suspension tower 40 in the vehicle-rearward direction, as indicated by an arrow S11 in FIG. 7. The collision load applied to the suspension tower 40 and acting in the vehicle-rearward direction is transmitted through the suspension tower brace 50 to the dash cross member 31, the front-pillar inner gusset 38, and the front pillar 10, as indicated by an arrow S12 in FIG. 7, and is then received by the front pillar 10. In addition, the collision load applied to the front side member 20 is transmitted via the cross reinforcement member 35 to the front pillar 10, and is received by the front pillar 10, as indicated by an arrow S13 in FIG. 7, and the collision load is also transmitted via the connecting member 25 to the cabin-lower-part strength member, and is received by the cabin-lower-part strength member.

Since the collision load applied to the dash cross member 31 is received by the front pillar 10, a reaction force acting from the dash cross member 31 in the vehicle-frontward direction is applied to the suspension tower brace 50. Because the second coupling portion 59 of the suspension tower brace 50 relative to the dash cross member 31 is located at a more vehicle-upward position than the first coupling portion 58 of the suspension tower brace 50 relative to the upper end 41 of the suspension tower 40, the suspension tower 40 receives a force acting in the vehicle-downwardly frontward direction from the suspension tower brace 50, as indicated by an arrow S15 in FIG. 7. With this force, the front side member 20 receives a force acting in the vehicle-downward direction, as indicated by an arrow S16 in FIG. 7.

In the meantime, a reaction force acting from the connecting member 25 is applied to the front side member 20 in the vehicle-obliquely upward direction, and this reaction force tends to upwardly curve the front side member 20, as indicated by an arrow S17 in FIG. 7.

In the state shown in FIG. 7, the force tending to push the front side member 20 downward by the force acting from the suspension tower brace 50 in the obliquely downward direction is greater than the force tending to upwardly curve the front side member 20 due to the force acting from the connecting member 25 in the obliquely upward direction; therefore, the front side member 20 is not curved upward, but is curved in the vehicle-width direction, so that the front side member 20 becomes crushed in the vehicle-longitudinal direction, to thereby sufficiently absorb the collision load. Hence, it is possible to effectively suppress the dash panel 30 from moving rearward due to the front collision. Since the collision load applied to the dash cross member 31 is received by the front pillar 10, it is possible to increase the reaction force acting in the vehicle-downwardly frontward direction onto the suspension tower brace 50. Accordingly, it is possible to more effectively suppress the front side member 20 from being curved upward so as to suppress the dash panel 30 from moving rearward.

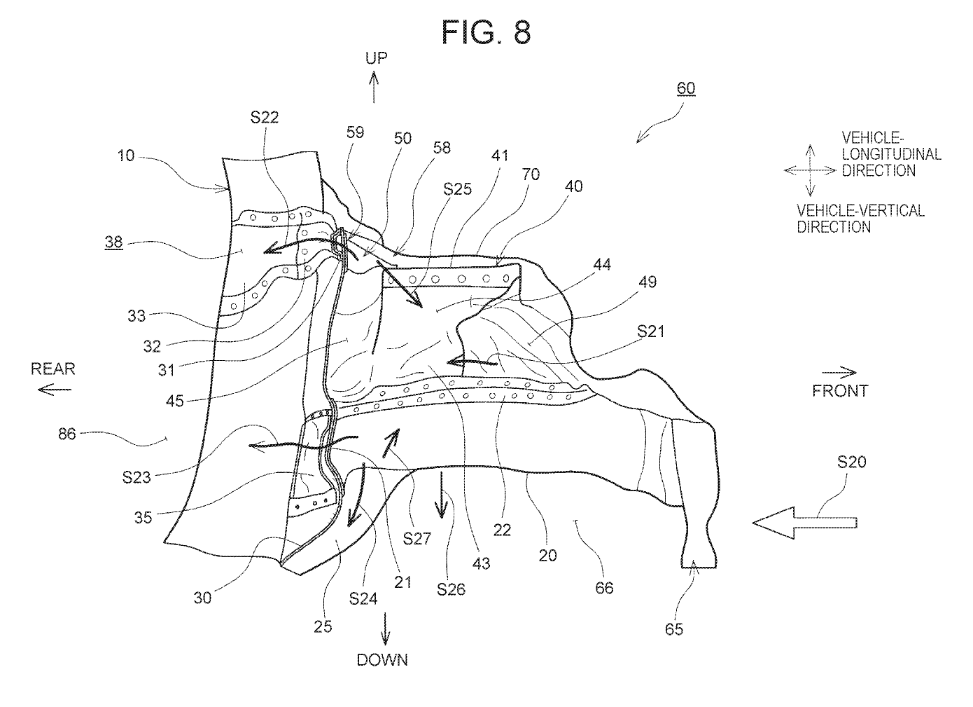

Next, after a little moment passes from the state in FIG. 7, as shown in FIG. 8, the dash cross member 31 and the cross reinforcement member 35 become deformed due to the collision load, so that the suspension tower 40 starts moving rearward from the state in FIG. 7. Because the front side member 20 is crushed in the vehicle-longitudinal direction due to the curve deformation thereof in the vehicle-width direction, wrinkles are caused to the first wheel house 49 located outward of the front side member 20 due to the deformation. In addition, the second wheel house 45 starts being crushed due to the deformation.

As with the description with reference to FIG. 7, the suspension tower 40 receives a force acting in the vehicle-downwardly frontward direction from the suspension tower brace 50, as indicated by an arrow S25 in FIG. 8, and this force pushes the front side member 20 in the vehicle-downward direction, as indicated by an arrow S26 in FIG. 8. Furthermore, a reaction force from the connecting member 25 acts on the front side member 20 in the vehicle-obliquely upward direction, as indicated by an arrow S27 in FIG. 8, and this force tends to curve the front side member 20 upward.

Also in this state, as with the state shown in FIG. 7, since the force pushing the front side member 20 downward is greater than the force curving the front side member 20 upward, the front side member 20 is not curved upward, but is further curved in the vehicle-width direction to be crushed in the vehicle-longitudinal direction, to thereby sufficiently absorb the collision load.

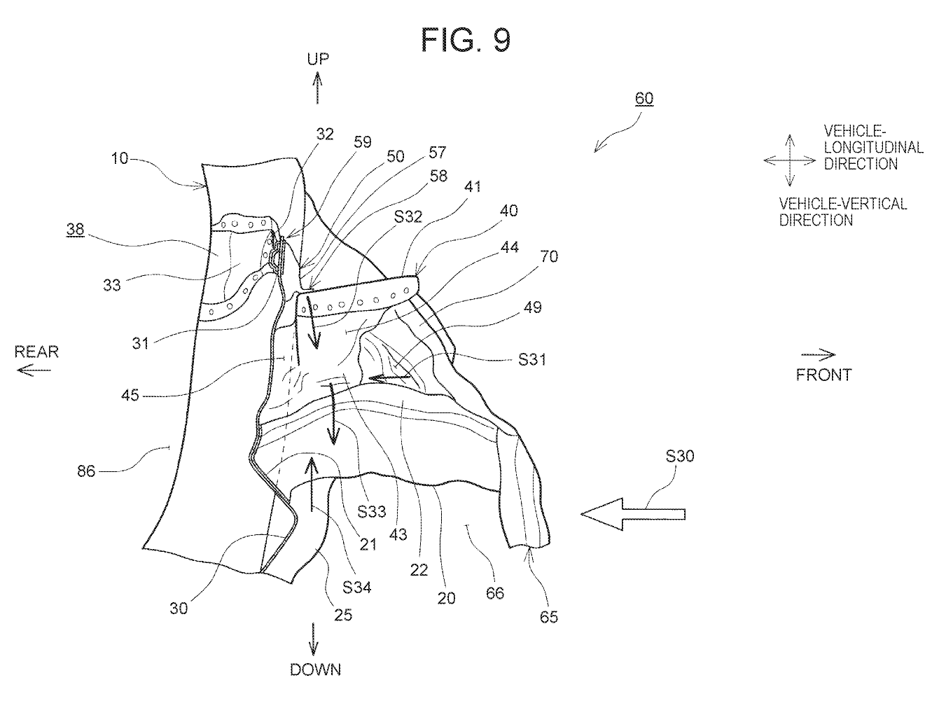

Next, after the time further passes from the state in FIG. 8, as shown in FIG. 9, the suspension tower brace 50 is buckling-deformed at the position of the hole 57 shown in FIG. 6A. This is because by providing the hole 57, compressive strength and bending strength become smaller at this portion, and thus this portion serves as the strength-reduced portion; consequently, stress concentration is generated, and buckling deformation is caused. Since the heights of the flanges 52 are set to be lowered from the dash panel side (the second coupling portion 59 side) toward the suspension tower side (the first coupling portion 58 side), the buckling deformation is caused at the position of the hole 57 as expected. When the suspension tower brace 50 is buckling-deformed, the collision load transmitted from the suspension tower brace 50 to the dash cross member 31 becomes smaller, and thus the dash cross member 31 is suppressed from moving rearward.

In the meantime, the collision load acting in the vehicle-rearward direction is applied to the suspension tower 40 from the front reinforcement member 65 and the front side member 20, as indicated by arrows S30, S31 shown in FIG. 9. The suspension tower 40 keeps moving rearward due to this collision load. When the suspension tower 40 moves rearward, as shown in FIG. 9, the first coupling portion 58 of the suspension tower brace 50 moves downward, and the suspension tower brace 50 located on the dash panel side from the hole 57 extends in the vehicle-vertical direction. In addition, the first coupling portion 58 of the suspension tower brace 50 coupled to the suspension tower 40 horizontally extends in the vehicle-longitudinal direction along the upper end 41 of the suspension tower 40. That is, as shown in FIG. 9, a part of the suspension tower brace 50 located closer to the dash panel side than the hole 57 erects in the vehicle-vertical direction, and a part of the suspension tower brace 50 located closer to the suspension tower side than the hole 57 extends in the substantially horizontal direction, so that the suspension tower brace 50 is deformed into an L-shape. As indicated by an arrow S32 in FIG. 9, the suspension tower brace 50, serving as a vertical member extending in the vehicle-vertical direction, downwardly pushes the suspension tower 40. Consequently, a force acting in the substantially vertical downward direction is applied from the suspension tower 40 to the front side member 20, as indicated by an arrow S33 in FIG. 9.

In this state, due to the deformations of the connecting member 25 and the front side member 20, as indicated by an arrow S34 in FIG. 9, a force acting in the vehicle-upward direction is applied from the connecting member 25 to the front side member 20. Consequently, the front side member 20 tends to be curved upward. However, as explained above, the downward force from the suspension tower 40 is applied to the front side member 20, and thus it is possible to suppress the front side member 20 from being greatly curved upward. Accordingly, the front side member 20 can sufficiently absorb the collision load by being further curved in the vehicle-width direction and crushed in the vehicle-longitudinal direction, to thereby suppress the dash panel 30 from moving rearward.

Furthermore, in the front structure 60 of the present embodiment, the end in the vehicle-width direction of the dash cross member 31 is coupled to the front-pillar inner gusset 38, and the front-pillar inner gusset 38 is coupled to the front pillar 10 so as to receive a collision load applied to the dash cross member 31 at the time of a front collision. Accordingly, it is possible to increase the force applied from the dash cross member 31 in the vehicle-downwardly frontward direction to the suspension tower 40, and also increase the force pushing the front side member 20 in the vehicle-downward direction so as to further suppress the front side member 20 from being greatly curved upward. With this, it is possible to more effectively suppress the dash panel 30 from moving rearward.

In this manner, the front structure 60 of the present embodiment can suppress the front side member 20 from being deformed in the vehicle-upward direction, and can suppress the dash panel 30 from moving rearward at the time of a front collision.

In the above described embodiment, the hole 57 is provided so as to configure the strength-reduced portion whose compressive strength and bending strength become reduced, to thereby cause stress concentration and buckling deformation at this portion; but the present disclosure is not limited to this, and for example, it may be configured to provide welding beads in a projecting shape on a lower surface in the vehicle-vertical direction of each web 51 so as to concentrate the stress on this portion, to thereby bring the suspension tower brace 50 to be buckling-deformed in an L-shape from the welding beads. In addition, multiple notches are provided on an upper surface in the vehicle-vertical direction of each web 51 so as to concentrate the stress on the notches, to thereby bring the suspension tower brace 50 to be buckling-deformed in an L-shape from the notches.

In the above described embodiment, it has been described that each suspension tower brace 50 is a grooved-sectional member having the web 51 and the two flanges 52 that oppose each other with the web 51 interposed therebetween, and the web 51 and the flanges 52 are arranged such that the web 51 is located at an upper position, and the flanges 52 extend in the vehicle-vertical direction; but the present disclosure is not limited to this shape. For example, each suspension tower brace 50 may be configured as a box-like sectional member, and the hole 57 for strength-reduction may be provided to the vicinity of the first coupling portion 58 relative to the upper end 41 of the suspension tower 40, or each suspension tower brace 50 may be configured as a plate-like member or a bar-like member.

As aforementioned, the present disclosure is not limited to the above-described embodiment, and may include any alterations and modifications without departing from the technical scope and the spirit of the present disclosure as defined in the appended claims.

What is claimed is:

1. A vehicle front structure comprising:
a dash panel partitioning a part frontward of a cabin;
a front side member disposed frontward of the dash panel in a vehicle-longitudinal direction;
a suspension tower coupled to a upper part of the front side member;
a dash cross member attached to the dash panel and extending in a vehicle-width direction, the dash cross member being located at a more vehicle-upward position than a upper end of the suspension tower; and
a suspension tower brace having a first end coupled to the dash cross member and a second end coupled to the upper end of the suspension tower,
the suspension tower brace including a first coupling portion coupled to the upper end of the suspension tower and a second coupling portion coupled to the dash cross member, the first coupling portion being located at a more vehicle-downward position than the second coupling portion.

2. The vehicle front structure according to claim 1, wherein
the suspension tower brace is connected to the upper end of the suspension tower at the first coupling portion, and is connected to the dash cross member at the second coupling portion,
so as to connect the upper end of the suspension tower brace to the dash cross member in the vehicle-longitudinal direction, and
the suspension tower brace extends in such a manner as to be inclined in a vehicle-vertical direction relative to the vehicle-longitudinal direction.

3. The vehicle front structure according to claim 1, wherein
the suspension tower brace includes a strength-reduced portion in a vicinity of the first coupling portion.

4. The vehicle front structure according to claim 3, wherein
the strength-reduced portion has a smaller bending strength than bending strength of other portions in the suspension tower brace.

5. The vehicle front structure according to claim 3, wherein
the suspension tower brace includes a web and two flanges, the two flanges facing each other, the web being between the two flanges,
the web and the two flanges are arranged such that the web is located at a more vehicle-upward position than the two flanges, the two flanges extending in a vehicle-vertical direction,
the two flanges are coupled to the dash cross member, the web being coupled to the upper end of the suspension tower, and
a hole configuring the strength-reduced portion is provided on the web in the vicinity of the first coupling portion.

6. The vehicle front structure according to claim 5, wherein
a height in the vehicle-vertical direction of each flange of the two flanges is lowered from the second coupling portion toward the first coupling portion.

7. The vehicle front structure according to claim 1, further comprising:
a front pillar disposed at a more vehicle-rearward position compared with the dash panel; and
a front-pillar inner gusset coupled to the front pillar, wherein
an end of the dash cross member in the vehicle-width direction is coupled to the front-pillar inner gusset.
